(19) United States
(12) Patent Application Publication
(10) Pub. No.: US 2005/0100086 A1
(43) Pub. Date: May 12, 2005

(54) Video coding and decoding method

(76) Inventors: Cecile Dufour, Paris (FR); Gwenaelle Marquant, Paris (FR); Stephane Edouard Valente, Paris (FR)

Correspondence Address: US Philips Corporation;Intellectual Property Department, PO Box 3001, Briarcliff Manor, NY, 10510, US

(21) Appl. No.: 10/498,764

(22) PCT Filed: Dec. 11, 2002
(86) PCT No.: PCT/IB02/05479

(30) Foreign Application Priority Data
Dec. 20, 2001 (EP) 0143320.3

(51) Int. Cl. H04N 7/12

(52) U.S. Cl. 375/240.01

(57) ABSTRACT

The invention relates to a video coding method and device applied to a sequence of frames and generating a coded bitstream in which each data item is described by means of a bitstream syntax allowing any decoder to recognize and decode all the elements of the content of said bitstream. According to the invention, which finds an application for instance within the video compression standard MPEG-4, the syntax comprises a specific one bit flag provided for indicating at a high level description the presence, or not, of a shape for each video object of the scenes of the sequence. This flag is transmitted in the coded bitstream, and its value is read at the decoding side for controlling correspondingly the decoding step.

### FIELD OF THE INVENTION

The present invention generally relates to the field of video compression and, for instance, more particularly to the video standards of the MPEG family (MPEG-1, MPEG-2, MPEG-4). More specifically, the invention concerns an encoding method applied to a video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel.

The invention also relates to an encoding device for implementing said method, to a transmittable video signal consisting of a coded bitstream generated by said encoding device, and to a device for receiving and decoding said video signal.

### BACKGROUND OF THE INVENTION

In the first video coding standards and recommendations (up to MPEG-2 and H.263), the video was assumed to be rectangular and to be described in terms of three separate channels:one luminance channel, carrying the varying black and white information on a given amount N of bits, eight bits for instance, and two chrominance channels, each one containing a digital signal equal to a value comprised in the range defined by a chrominance representation on a given amount M of bits, eight bits for instance.

With MPEG-4, an additional channel has been introduced: the alpha channel (also referred to as the “arbitrary shape channel” in MPEG-4 terminology), for describing the contour of each object present in the video sequence. Other additional channels may be provided, for example, without being exhaustive, the transparency channel, required for video contents composed of different objects which may be superimposed (for an object, this transparency channel may be opaque, the object texture therefore overwriting the texture of the other objects, or half-transparent, the texture on the display then resulting from the blending of the textures of the different objects), the disparity channel, useful for the applications for which two views of the content are required (so that the content can be visualized on a display enabling stereoscopic viewing), or the depth channel (in case of applications where a three-dimensional navigation is enabled).

In the MPEG-4 standard, the only mean to describe such additional channels is the use of the so-called syntactic element “video_object_layer_shape_extension”. As indicated in the NTEG-4 document w3056, “Information Technology—Coding of audio-visual objects—Part 2: Visual”, ISO/IEC/JTC1/SC29AWG11, Maui, USA, December 1999, pages 111 and 112, the syntactic element “video_object_layer_shape” is a 2-bit integer identifying the shape type of a video object layer (see table 6-14, page 112), and the element “video_object_layer_shape_extension” is a 4-bit integer identifying the number (up to 3) and type of auxiliary components that can be used (see table V2-1, page 112, in which a limited number of types and combinations are defined, but the selection of the USER DEFIED type allows to have more applications available). When “video_object_layer_shape” is 00, it means (table 6-14) that the object is rectangular. The description of this rectangular object requires to transmit the size of the rectangle in terms of width and height, which is given in the document w3056, page 36, lines 26-32 (part: if (video_object_layer_shape ==“rectangular”) { }) and requires 29 bits. For transmitting additional channels like the disparity channel or the depth channel of a rectangular object with the MPEG-4 syntax, this object must be declared as non rectangular by setting “video_object_layer_shape” to 11 (grayscale). Once the object is declared as being grayscale (although it is rectangular), the syntax forces to send bits describing the shape of the object, which is done at the macroblock level according to the syntax given in the following parts of the document w3056:
(a) page 52, § 6.2.6 Macroblock, lines 1-6;
(b) page 56, § 6.2.6.1 MB Binary shape coding, lines 1-5,
(c) from page 128, § 6.3.5.3 Shape coding, to page 129, line 8, and the table 6.26.

It appears therefore that, according to the syntax and the semantic provided by MPEG-4, the support for the transmission of additional channels like the disparity or depth channels is only provided for objects having a shape (or contour), the description of which has then to be sent with a given number of bits. The resulting waste of bits is, for CIF pictures for instance, of at least 396 bits per frame, i.e. at least one bit per macroblock to provide the bab_type information mentioned in the document w3056, § 6.3.5.3 (bab_type=a variable length code which in fact comprises between 1 and 7 bits), whereas only 29 bits would have been sufficient. In the case one wants to transmit the luminance and chrominance channels and for instance one additional channel like disparity of a rectangular object, MPEG-4 is therefore sub-optimal in terms of coding efficiency.

### SUMMARY OF THE INVENTION

It is therefore an object of the invention to propose a video coding method allowing to avoid this waste of bits and therefore to improve the coding efficiency.

To this end, the invention relates to a method such as defined in the introductory part of the description and which is moreover characterized in that said syntax comprises a specific one bit flag indicating at a high description level the presence, or not, of a shape for each video object of the scenes of the sequence.

The invention also relates to a corresponding encoding device, and to a transmittable video signal consisting of a coded bitstream generated by an encoding method applied to a sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel, said signal being further characterized in that said coded bitstream also comprises a specific one bit flag indicating at a high description level the presence, or not, of a shape for each video object of the scenes of the sequence. The invention finally relates to a video decoder for receiving and decoding such a transmittable video signal.

### DETAILED DESCRIPTION OF THE INVENTION

To solve the problem of waste of bits explained above, it is proposed, according to the invention, to separate the description of the shape (or contour) channel from the description of additional channels. This operation is implemented by providing in the bitstream an indication about the presence of shape which would be separated from the possible indication of the presence of additional channels like disparity or depth channel. This indication consists of a specific one bit flag introduced, according to the invention, at a high description level (at least equivalent to the Video Object Layer—or VOL—MPEG-4 level).

This additional descriptive step is implemented for example in the following manner. A syntactic element is defined, such as, in the present case:
Video_object_layer_shape
   and the semantic meaning of this element is:“this is a one bit flag indicating, if set to a given value (for example, one), the presence of a shape (or contour) channel”. If this syntactic element is sent to 1, the contour or shape channel is present and should be decoded. If not, no description of shape or contour is expected.

This technical solution is advantageous in that the support for the transmission of additional channels is now not dependent on the fact that the objects have or not a shape, which provides a more flexible syntax and leads to an improved coding efficiency.

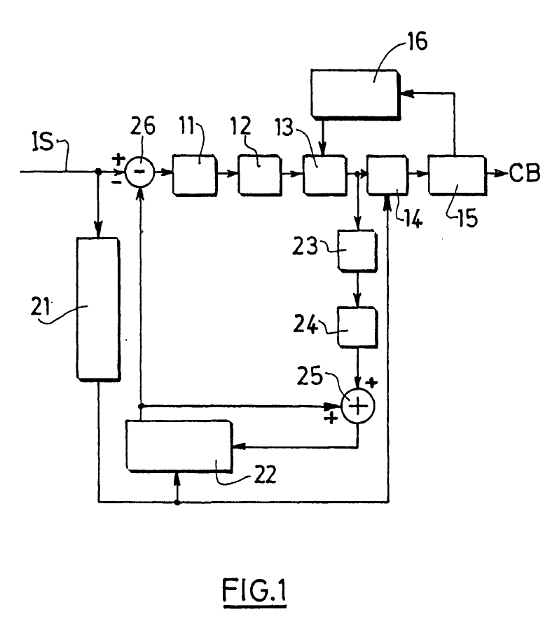

The video coding method described above may be implemented in a coding device such as for instance the one illustrated in FIG. 1 showing an example of an MPEG coder with motion compensated interframe prediction, said coder comprising coding and prediction stages. The coding stage itself comprises in series a mode decision circuit 11 (for determining the selection of a coding mode I, P or B as defined in MPEG), a DCT circuit 12, a quantization circuit 13, a variable-length coding circuit 14 and a buffer 15 associated to a rate control circuit 16 for adapting the quantization in the circuit 13 according to the content of said buffer. The prediction stage comprises in series a motion estimation circuit 21 followed by a motion compensation circuit 22, and, in series, an inverse quantization circuit 23, an inverse DCT circuit 24 and an adder 25. The output of the adder 25 is received on a second input of the motion compensation circuit 22, and the output of said circuit 22 is received on a second input of the adder 25 (in the same time, said output of the circuit 22 is the output of the prediction stage). A subtractor 26 allows to send towards the coding stage (11 to 16) the difference between the input signal IS of the coding device and the predicted signal available at the output of the prediction stage (i.e. at the output of the circuit 22). This difference, or residual, is the bitstream that is coded, and the output signal CB of the buffer 15 is the coded bitstream that, according to the invention, will include the syntactic element indicating at a high description level, for each channel described in the coded bitstream, the presence, or not, of an encoded residual signal.

Another example of coding device may be based on the specifications of the BTEG-4 standard. In the MPEG-4 video framework, each scene, which may consist of one or several video objects (and possibly their enhancement layers), is structured as a composition of these objects, called Video Objects (VOs) and coded using separate elementary bitstreams. The input video information is therefore first split into VOs by means of a segmentation circuit, and these VOs are sent to a basic coding structure that involves shape coding, motion coding and texture coding. Each VO is, in view of these coding steps, divided into macroblocks, that consist for example in four luminance blocks and two chrominance blocks for the format 4:2:0 and are encoded one by one. According to the invention, the multiplexed bitstream including the coded signals that result from said coding steps will include the specific flags for describing, in the coded bitstream to be transmitted and/or stored, the maximum frame rate of each described channel.

Reciprocally, according to a corresponding decoding method, these specific flags, transmitted to the decoding side, are read by appropriate means in a video decoder receiving the coded bitstream that includes said flags and carrying out said decoding method. The decoder, which is able to recognize and decode all the segments of the content of the coded bitstream, reads said additional syntactic elements and knows the maximum frame rate of each described channel. Such a decoder may be of any MPEG-type, as the encoding device, and its essential elements are for instance, in series, an input buffer receiving the coded bitstream, a VLC decoder, an inverse quantizing circuit and an inverse DCT circuit. Both in the coding and decoding device, a controller may be provided for managing the steps of the coding or decoding operations.

The foregoing description of the preferred embodiments of the invention has been presented for purposes of illustration and description. It is not intended to be exhaustive or to limit the invention to the precise forms disclosed, and obviously modifications and variations, apparent to a person skilled in the art and intended to be included within the scope of this invention, are possible in light of the above teachings.

It may for example be understood that the coding and decoding devices described herein can be implemented in hardware, software, or a combination of hardware and software, without excluding that a single item of hardware or software can carry out several functions or that an assembly of items of hardware and software or both carry out a single function. The described methods and devices may be implemented by any type of computer system or other adapted apparatus. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized.

The present invention can also be embedded in a computer program product, which comprises all the features enabling the implementation of the methods and functions described herein and when loaded in a computer system- is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation ; and/or (b) reproduction in a different material form.

1. A video encoding method applied to a video sequence corresponding to successive scenes, said method generating, for coding all the video objects of said scenes, a coded bitstream constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel, said method being further characterized in that said syntax comprises a specific one bit flag indicating at a high description level the presence, or not, of a shape or contour for each video object of the scenes of the sequence.

2. A method according to claim 1, in which, if said specific flag is set to a given value, the shape of an object is present and has to be decoded, while no description of shape is expected if said flag is set to the other value.

3. A device for encoding a video sequence corresponding to successive scenes, said device comprising means for structuring each scene of said sequence as a composition of video objects (VOs), means for coding the shape, the motion and the texture of each of said VOs, and means for multiplexing the coded elementary streams thus obtained into a single coded bitstream constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel, said device being further characterized in that it also comprises means for introducing in said coded bitstream, a specific one bit flag indicating at a high description level the presence, or not, of a shape or contour for each video object of the scenes of the sequence.

4. A transmittable video signal consisting of a coded bitstream generated by a video encoding method applied to a sequence corresponding to successive scenes, said coded bitstream, generated for coding all the video objects of said scenes, being constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel, said signal being further characterized in that the coded bitstream also comprises a specific one bit flag indicating at a high description level the presence, or not, of a shape or contour for each video object of the scenes of the sequence.

5. A video decoding method applied to a video signal consisting of a coded bitstream generated by a video encoding method applied to a sequence corresponding to successive scenes, said coded bitstream, generated for coding all the video objects of said scenes, being constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel, said coded bitstream also comprising a specific one bit flag indicating at a high description level the presence, or not, of a shape or contour for each video object of the scenes of the sequence, said decoding method being characterized in that it includes a reading step for reading the value of said specific flag and controlling a decoding step according to said value.

6. A device for receiving and decoding a video signal consisting of a coded bitstream generated by a video encoding method applied to a sequence corresponding to successive scenes, said coded bitstream, generated for coding all the video objects of said scenes, being constituted of encoded video data in which each data item is described by means of a bitstream syntax allowing to recognize and decode all the elements of the content of said bitstream, said content being described in terms of separate channels comprising at least a luminance channel, with or without chrominance channels, and at least one additional channel, said coded bitstream also comprising a specific one bit flag indicating at a high description level the presence, or not, of a shape for each video object of the scenes of the sequence, said decoding device being further characterized in that it comprises means for reading the value of said specific flag and controlling correspondingly a decoding step according to said value.
